(19) United States
(12) Patent Application Publication
(10) Pub. No.: US 2007/0132251 A1
(43) Pub. Date: Jun. 14, 2007

(54) Energy absorber applied to automobile front-bumper

(76) Inventor: Jeong Ho Lee, Suwon-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/302,070

(22) Filed: Dec. 12, 2005

(51) Int. Cl. B60R 19/22

(52) U.S. Cl. 293/109

(57) ABSTRACT

An energy absorber for an automobile front-bumper, in which the energy absorber is mounted on the inner side of the automobile front-bumper to absorb impact. The energy absorber includes a central part, and comer parts each positioned at the left and right sides of the central part, wherein the central part is fabricated to be thicker than the comer parts using resin foam foamed with a high magnification, and the comer parts is fabricated to be thinner than the central part using resin foam foamed with a low magnification, thereby increasing the impact absorption effect and the rigidity of the energy absorber.

### BACKGROUND OF THE INVENTION

1. Field of the Invention

The present invention relates to an energy absorber for an automobile front-bumper, and more particularly to an energy absorber fabricated as a component is divided into three density areas and a foaming part to protect pedestrians by lowering the initial value of deceleration in the event of a collision.

2. Description of the Prior Art

A conventional front-bumper energy absorber is typically fabricated from polypropylene. When fabricating such an energy absorber, resin material is sprayed on a mold modeled after the energy absorber by employing a steam chest method and then heat is applied to foam and expand the raw material.

As well known in the art, resin form exhibits a tendency that as its foaming magnification is increased, the inter-particle distance and expansion degree are increased while the density and strength are reduced, whereas as its foaming magnification is reduced, the inter-particle distance and expansion degree are reduced while the density and strength are increased.

However, a conventional energy absorber includes a central part having a thickness of 80 mm and right and left corner parts each positioned at opposite sides of the central part and having a thickness of 65 mm at the comers the energy absorber is typically fabricated using resin foam, of which the foaming magnification is 40.

The difference in thickness between the central part and the comer parts of the energy absorber is because it is necessary to style the comer parts of the bumper in a round form on account of the design of an automobile. For this purpose, restrictions are imposed that the comer parts shall be fabricated to be thinner than the central part in the order of about 15 mm.

However, results obtained in collision tests using the energy absorber with reference to standards specified in the regulation of pedestrian protection against collision enforced in the EU, indicate there may be problems in that although the central parts of the energy absorber meet with the above-mentioned regulation when the front-bumper of an automobile collides with the lower leg foam part, the comer parts do not meet with the above-mentioned regulation because the deceleration is not properly controlled as the initial value of the deceleration is too high.

### SUMMARY OF THE INVENTION

Embodiments of the present invention provide an energy absorber for an automobile front-bumper, wherein the energy absorber, which is mounted on the inner side of the automobile front-bumper, is fabricated as a component divided into three density areas, and a foaming part is provided in the energy absorber so as to protect a pedestrian by lowering the initial value of deceleration in the event of a collision.

In an exemplary embodiment of the present invention, an energy absorber for an automobile front-bumper, in which the energy absorber is mounted on the inner side of the automobile front-bumper to absorb impact, includes: a central part, and comer parts each positioned at the left and right sides of the central part, wherein the central part is fabricated to be thicker than the comer parts using resin foam foamed with a high magnification, and the comer parts is fabricated to be thinner than the central part using resin foam foamed with a low magnification.

According to one embodiment of the present invention, the resin foam is polypropylene foam, and the foaming magnification of the resin foam of the central part is 40 and the foaming magnification of the resin foam of the comer parts is 15. In addition, a foaming part in a form of a concave channel may be longitudinally formed at a lower area in the front central part of the inventive energy absorber.

### BRIEF DESCRIPTION OF THE DRAWINGS

The objects, features and advantages of the present invention will be more apparent from the following detailed description taken in conjunction with the accompanying drawings, in which:

FIG. 1 is a perspective view showing the rear side of an energy absorber according to the present invention;

FIG. 2 is a perspective view showing the front central part of the inventive energy absorber;

FIG. 3 is cross-sectional view showing the inventive front-bumper of an automobile collided at an automobile collision test; and

FIG. 4 is a graph showing the relationship between knee-bending angle and time on the basis of test results in comparison of the present invention with the prior art.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

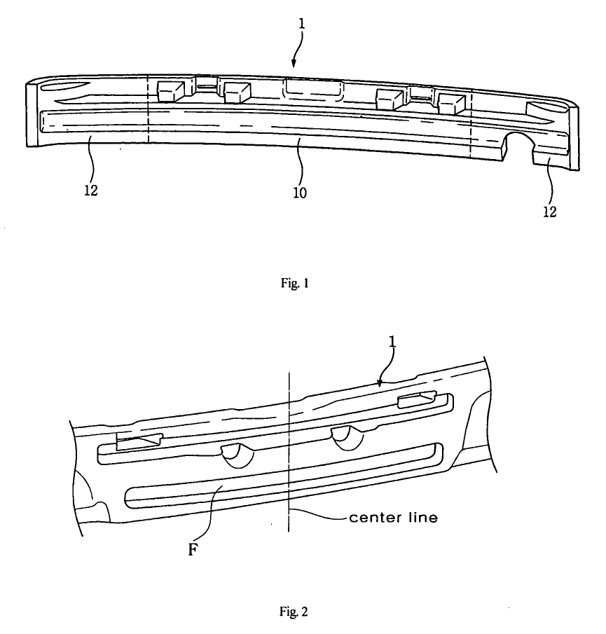

Referring first to FIG. 1, energy absorber 1, according to one exemplary embodiment of the invention includes a central part 10 and two comer parts 12 each positioned at the opposite sides of the central part 10. Although boundaries between the central part 10 and the two comer parts 12 are indicated by dot lines, the present invention is not limited by the boundary lines, which can be varied according to manufacturing facilities and installation environments of such an energy absorber.

Energy absorber 1 has a thickness in the central part of about 80 mm and a thickness in the comer parts 12 of about 65 mm. The central part is fabricated from a resin foam foamed with a relatively high magnification, for example, with a foaming magnification of 40, and the comer parts 12 are fabricated from a resin foam foamed with a relatively low magnification, for example, with a foaming magnification of 12.

When the polypropylene foam is foamed with the foaming magnification of 12, the polypropylene foam is relatively superior in density, tensile strength and compression strength: the apparent density is in the range of about 0.060 to 0.005 g/cm³, the lower limit of tensile strength is about 6.0 kgf/cm², and the lower limit of compression strength is about 2.0 kgf/cm² (when the compression ratio is 20%). accordingly, if the polypropylene foam is applied to the energy absorber 1, it can be expected that the rigidity and the impact absorption effect of the energy absorber can be increased, in particular, in the comer parts.

Although the inventive energy absorber 1 described above as fabricated in a single piece, it consists of a component internally divided into three density areas, i.e., one central part 10 and two comer parts 12. Potential disadvantages caused in the central part 10 due to low strength and density is compensated by increasing the thickness of the central part 10, and the disadvantage caused in the comer parts 12 due to thin thickness is compensated by increasing the strength and density of the comer parts, whereby a structure superior in reinforcement and impact-absorption capability in balance can be provided over the entire length of the energy absorber I uniformly with little variation.

FIG. 2 is a perspective view showing the front central part of the inventive energy absorber 1, with foaming part F in a concave channel form provided at the lower area thereof. The foaming part F is formed to extend to the left and right sides about the longitudinal center of the energy absorber 1, wherein the length of the foaming part F can be properly adjusted depending on automobile types and test environments and even extended to the comer parts.

The foaming part F is advantageous in that the foaming part provides an extra space for allowing the collided part to move by the corresponding space in the event of a collision. Foaming part F increases the impact absorption area of the energy absorber 10 surrounding the concave channel-shaped space so that the impact can be more efficiently absorbed, and in that the foaming part can decrease the initial value of deceleration, in particular, after the collision.

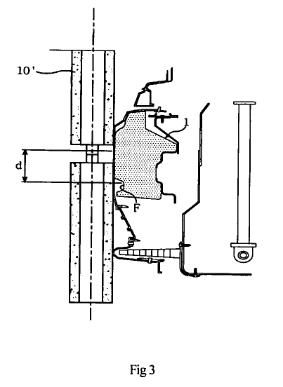

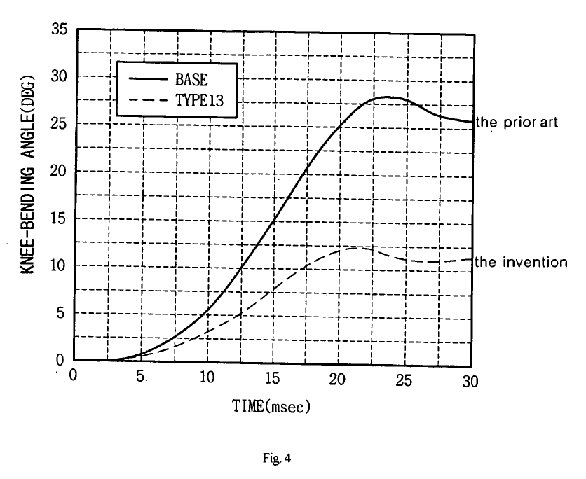

FIG. 3 illustrates an auto collision test, a collision test member 10′. When the front bumper including energy absorber 1, the energy serves to absorb the impact and deaccelerate the vehicle in an attempt to reduce pedestrian injury. In such a test, the test member may be provided as a form leg member with upper and lower parts. In that case, it is preferable that the foaming part F is positioned at a distance d of about 66 mm below from the center line between the upper leg foam part and the lower leg foam part. This is because a sensor for measuring the deceleration at time of collision with the lower leg foam at the automobile collision test is positioned at that position and that position is important in protecting lower parts of legs of a pedestrian.

FIG. 4 is a graph showing the test results of time taken to reach the knee-bending angle (X-Y) at the lower leg foam in the test shown in FIG. 3 in comparison of the present invention with the prior art. The prior art is indicated by a solid line and the present invention is indicated by a dot line.

As can be seen from the graph, the present invention requires much more time prior to arriving at a predetermined bending angle as compared to the prior art, which means that the initial value of deceleration has been greatly reduced according to the present invention.

In addition, because bending angle never exceeds 13 degrees in the present invention, it can be confirmed that the impact absorption effect can be improved in the inventive energy absorber as compared to conventional absorber.

As described above, according to the present invention, by fabricating an energy absorber mounted in an automobile front-bumper as a component divided into three density areas and providing a foaming part in the energy absorber, it is possible to lower the initial value of deceleration and to improve the impact absorption effect and the rigidity of the energy absorber.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An energy absorber for an automobile front-bumper, in which the energy absorber is configured and dimensioned to be mounted on the inner side of the automobile front-bumper to absorb impact, the energy absorber comprising:
a central part, and comer parts each positioned at the left and right sides of the central part, wherein the central part is fabricated to be thicker than the comer parts using resin foam foamed with a high magnification, and the comer parts is fabricated to be thinner than the central part using resin foam foamed with a low magnification.

2. An energy absorber as claimed in claim 1, wherein the resin foam is polypropylene foam, the foaming magnification of the resin foam of the central part is 40, and the foaming magnification of the resin foam of the comer parts is 15.

3. An energy absorber as claimed in claim 1, wherein a foaming part in a form of a concave channel is longitudinally formed at a lower area in a front of the central part of the energy absorber.

4. An energy absorber as claimed in claim 2, wherein a foaming part in a form of a concave channel is longitudinally formed at a lower area in a front of the central part of the energy absorber.
